(19) United States
(12) Patent Application Publication
(10) Pub. No.: US 2014/0219182 A1
(43) Pub. Date: Aug. 7, 2014

(54) DEVICE TRIGGERING SOLUTIONS

(71) Applicants: Devaki Chandramouli, Plano, TX (US); Robert Zaus, Munich (DE); Rainer Liebhart, Munich (DE)

(72) Inventors: Devaki Chandramouli, Plano, TX (US); Robert Zaus, Munich (DE); Rainer Liebhart, Munich (DE)

(73) Assignee: NOKIA SOLUTIONS AND NETWORKS OY, Espoo (FI)

(21) Appl. No.: 14/347,655

(22) PCT Filed: Sep. 29, 2011
(86) PCT No.: PCT/US2011/053931

§ 371 Date: Mar. 27, 2014

(51) Int. Cl. H04W 68/02

(52) U.S. Cl. CPC H04W 68/02
USPC 370/328

(57) ABSTRACT

For many machine to machine applications a poll model can be used for communications between machine type communication devices and the machine type communication server. In such and other communication systems device triggering solutions can permit efficient communication. According to certain embodiments, a method can include preparing an attach request to be sent to a network element, wherein the attach request includes an indication of a device trigger capability of a user equipment. The method can also include activating the user equipment in response to a received device trigger.

### BACKGROUND

1. Field

For many machine to machine applications a poll model can be used for communications between machine type communication devices and the machine type communication server. In such and other communication systems device triggering solutions can permit efficient communication.

2. Description of the Related Art

Current device triggering approaches generally either require the assignment of a mobile subscriber integrated services digital number (MSISDN) to a device or circuit switched (CS) infrastructure or both. For example, short message service (SMS) over the SGs interface may require MSISDN as well as mobile switching center (MSC) and short message service center (SMSC) deployment.

### SUMMARY

According to certain embodiments, a method includes preparing an attach request to be sent to a network element, wherein the attach request includes an indication of a device trigger capability of a user equipment. The method also includes activating the user equipment in response to a received device trigger.

A method, in certain embodiments, includes storing a device trigger capability of a user equipment received from the user equipment. The method also includes triggering the user equipment upon receiving a device trigger message from a machine type communication interworking function.

A method includes, according to certain embodiments, translating an application identifier to an access point name in response to receiving a device trigger message for a user equipment from a machine type communication server.

According to certain embodiments, an apparatus includes at least one memory including computer program instructions and at least one processor. The at least one memory and computer program instructions are configured to, with the at least one processor, cause the apparatus at least to prepare an attach request to be sent to a network element, wherein the attach request includes an indication of a device trigger capability of a user equipment. The at least one memory and computer program instructions are also configured to, with the at least one processor, cause the apparatus at least to activate the user equipment in response to a received device trigger.

An apparatus, in certain embodiments, includes at least one memory including computer program instructions and at least one processor. The at least one memory and computer program instructions are configured to, with the at least one processor, cause the apparatus at least to store a device trigger capability of a user equipment received from the user equipment. The at least one memory and computer program instructions are also configured to, with the at least one processor, cause the apparatus at least to trigger the user equipment upon receiving a device trigger message from a machine type communication interworking function.

An apparatus includes, in certain embodiments, at least one memory including computer program instructions and at least one processor. The at least one memory and computer program instructions are configured to, with the at least one processor, cause the apparatus at least to translate an application identifier to an access point name in response to receiving a device trigger message for a user equipment from a machine type communication server.

According to certain embodiments, an apparatus includes preparing means for preparing an attach request to be sent to a network element, wherein the attach request includes an indication of a device trigger capability of a user equipment. The apparatus also includes activating means for activating the user equipment in response to a received device trigger.

An apparatus, in certain embodiments, includes storing means for storing a device trigger capability of a user equipment received from the user equipment. The apparatus also includes triggering means for triggering the user equipment upon receiving a device trigger message from a machine type communication interworking function.

An apparatus includes, according to certain embodiments, receiving means for receiving a device trigger message for a user equipment from a machine type communication server. The apparatus also includes translating means for translating an application identifier to an access point name in response to receiving the device trigger message.

According to certain embodiments, a non-transitory computer readable medium is encoded with instructions that, when executed in hardware, perform a process. The process includes preparing an attach request to be sent to a network element, wherein the attach request includes an indication of a device trigger capability of a user equipment. The process also includes activating the user equipment in response to a received device trigger.

A non-transitory computer readable medium, in certain embodiments, is encoded with instructions that, when executed in hardware, perform a process. The process includes storing a device trigger capability of a user equipment received from the user equipment. The process also includes triggering the user equipment upon receiving a device trigger message from a machine type communication interworking function.

A non-transitory computer readable medium is, according to certain embodiments, encoded with instructions that, when executed in hardware, perform a process. The process includes translating an application identifier to an access point name in response to receiving a device trigger message for a user equipment from a machine type communication server.

### BRIEF DESCRIPTION OF THE DRAWINGS

For proper understanding of the invention, reference should be made to the accompanying drawings, wherein:

FIG. 1A illustrates delivery of a device trigger using short message service encoded at the mobility management entity, with the user equipment in idle mode according to certain embodiments.

FIG. 1B illustrates delivery of a device trigger using short message service encoded at the mobility management entity, with the user equipment in active mode according to certain embodiments.

FIG. 2 illustrates device trigger delivery using service accept, with the user equipment in idle mode according to certain embodiments.

FIG. 3 illustrates device trigger delivery using a non-access stratum message when the user equipment is in idle mode according to certain embodiments.

FIG. 4 illustrates device trigger delivery using a non-access stratum message, when the user equipment is in connected mode according to certain embodiments.

FIG. 5 illustrates a method according to certain embodiments.

FIG. 6 illustrates another method according to certain embodiments.

FIG. 7 illustrates a further method according to certain embodiments.

### DETAILED DESCRIPTION

A poll model for communication between machine type communication (MTC) devices and a machine type communication server may be of particular value to, for example, machine to machine (M2M) applications. This may be because a person using the services of the machine type communication server, known as the machine type communication user, may want to be in control of communication from machine type communication devices, and may not allow machine type communication devices to randomly access the machine type communication server. Also for applications where normally the machine type communication devices initiate communications, there may occasionally be a need for the machine type communication server to poll data from machine type communication devices.

If a machine type communication server has an internet protocol (IP) address available for a device from which it needs to poll data, the server may try to communicate with the device over IP using the IP address. If the communications fails, or if no IP address is available for the device, the machine type communication server can use a machine type communication device trigger mechanism to try to establish the communication. This may cause a packet data protocol (PDP)/packet data network (PDN) connection to be established (if such a connection does not already exist) or re-established (if the connection is not working, for example, after an error condition in the network). Some machine type communication users may desire it to be guaranteed that machine type communication devices can only be triggered by authorized machine type communication servers. If the network is not able to trigger the machine type communication device, for example due to network congestion, the network may report the trigger failure to the machine type communication server. The machine type communication device trigger can be a service provided by a 3rd Generation Partnership Project (3GPP) system for the machine type communication server over control plane signaling.

Triggering of machine type communication devices can be based on the use of an identifier identifying the machine type communication device that needs to be triggered. The identifier used by the machine type communication user in a triggering request to the machine type communication server can be different from the identifier used by the machine type communication server in a triggering request to a public land mobile network (PLMN) network.

Device triggering in, for example, release 11 (rel-11) of 3GPP may be configured to provide certain functionalities. For example, it may have the ability to trigger devices without the assignment of mobile subscriber integrated services digital network number (MSISDN) to device. It may also have the ability to trigger devices without the need for circuit switched (CS) infrastructure. Conventional approaches either require the assignment of an MSISDN or need circuit switched infrastructure, or both.

Certain embodiments, however, provide a solution for triggering a machine type communication device without the use of an MSISDN and without the need for heavy infrastructure changes.

In the example embodiments set forth below, the interface between machine type communication server and machine type communication interworking function (MTC-IWF) can use any protocol (for example, hypertext transfer protocol (http)). Likewise, the interface between the MTC-IWF and a home subscriber server (HSS) or MTC-IWF and mobility management entity (MME) can use any protocol (for example, Diameter or general packet radio service (GPRS) tunneling protocol (GTP). Moreover, the approaches described can be used in the case of universal mobile telecommunication system (UMTS) terrestrial radio access network (UTRAN), evolved UTRAN (E-UTRAN), or global system for mobile communications (GSM) enhanced data rates for GSM evolution (EDGE) radio access network (GERAN). For device triggering via UTRAN or GERAN, in the following descriptions the mobility management entity could be substituted by a serving GPRS support node (SGSN).

Thus, there are no assumptions on the protocols for these interfaces, and they can be configured based on deployment needs.

Approach 1

In a first embodiment, delivery of device triggering information from a mobility management entity (MME) to a user equipment (UE) in an short message service (SMS) encoded message. This approach can use temporary identifiers for delivering the message to the user equipment.

In this embodiment, the encoding and sending an SMS message are performed at the mobility management entity and a temporary identifier can be used to deliver the SMS. Mapping the application identifier to APN can be performed in the MTC-IWF.

On the network side, according to a conventional technique, the SMS message, which may be in the form of a transfer protocol data unit (TPDU), is formatted by the short message service center (SMSC) and relayed transparently by the mobility management entity or SGSN. More precisely, between the user equipment and the SGSN or user equipment and mobile switching center (MSC), the TPDU is further encapsulated in a relay protocol data unit (RPDU), which in turn is encapsulated in a control protocol data unit (CPDU).

Thus, in this embodiment, if the TPDU is created by a mobility management entity or MTC-IWF, the mobility management entity or MTC-IWF also provides the RPDU and CPDU, which are normally formatted by the mobile switching center, when a short message is sent via SGs interface. Accordingly, in certain embodiments an SMS is created by a mobility management entity and/or an MTC-IWF without the need for an SMSC and/or MSC.

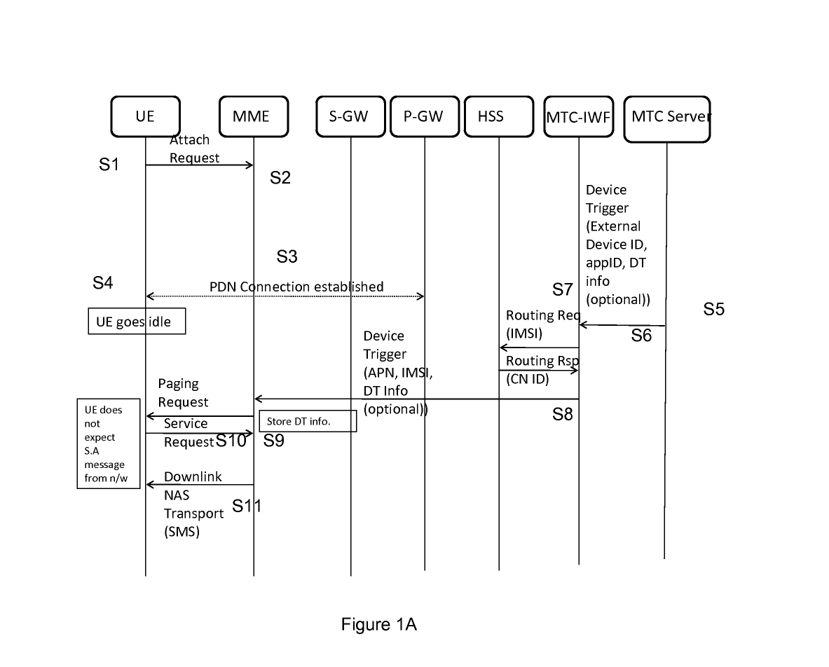

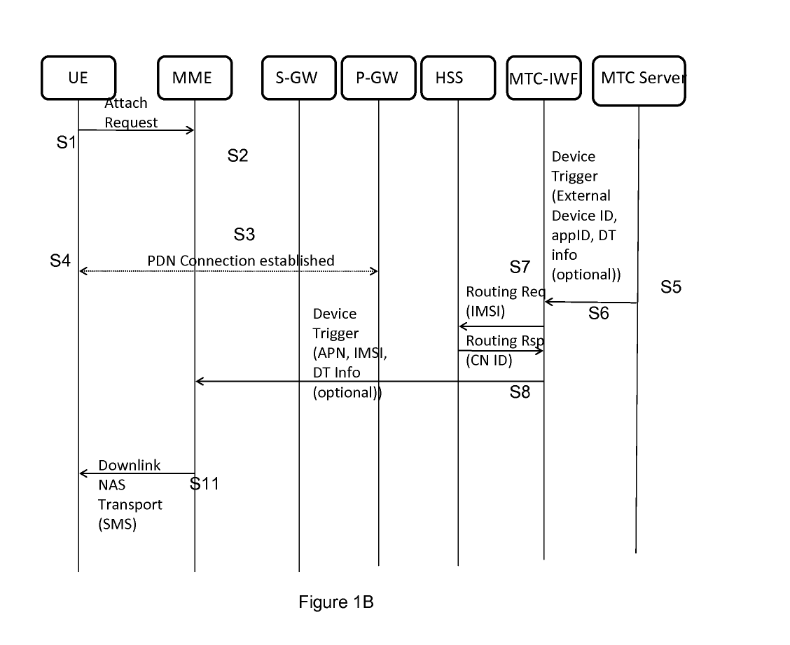

FIG. 1A illustrates delivery of a device trigger using short message service encoded at the mobility management entity, with the user equipment in idle mode according to certain embodiments. Some details that are not relevant to a device trigger procedure are not shown or discussed.

As shown in FIG. 1A, at S1, the user equipment (UE) can initiate an attach request and can indicate the user equipment's device trigger capabilities. Then, at S2, the mobility management entity (MME) can process the attach procedure. At S3, the packet data network (PDN) connection for the device has been established either as part of an attach procedure (for E-UTRAN) or subsequently (for UTRAN or, GERAN; for GERAN and UTRAN, establishment of a PDN connection is optional, that is to say it is not needed for the device trigger procedure). At S4, the UE goes idle. Then, at S5, the machine type communication (MTC) user identifies the need to trigger the device and informs the machine type communication server. The machine type communication server, at S6, requests the machine type communication interworking function (MTC IWF) to trigger the device. The server can do this by providing, for example, the external identifier, application identifier for the device, and so on.

The MTC-IWF ensures, at S7, that the request is an authentic request. The MTC-IWF may translate the application identifier (appID) to access point name (APN) and external identifier (extID) to international mobile subscriber identity (IMSI) and request the routing info (serving core network (CN) identifier (ID)) from a home subscriber server (HSS) by providing the IMSI for the device. The CN ID could be an IP address or fully qualified domain name (FQDN).

At S8, the MTC-IWF can use the CN ID to send a device trigger request message to the serving mobility management entity/serving GPRS support node (SGSN). The mobility management entity/SGSN can receive the device trigger (DT) message, notice that the device is in idle mode. Hence, at S9, the mobility management entity/SGSN can store the device trigger information and can pages the UE.

The user equipment, at S10, responds with a service request message (in GERAN: the user equipment may replay with a logical link control (LLC) frame). Then, at S11, the network formats an SMS message (TPDU encapsulated in RPDU, encapsulated in CPDU) with the necessary device trigger information and sends it in a downlink non-access stratum (NAS) transport message to the user equipment.

FIG. 1B illustrates delivery of a device trigger using short message service encoded at the mobility management entity, with the user equipment in active mode according to certain embodiments. As shown in FIG. 1B, the flow of signals can be similar to that in FIG. 1A. However, the storage of the device trigger information, paging of the user equipment and response of the user equipment to the paging can be omitted.

Approach 2

In a second embodiment delivery of device trigger information from the mobility management entity is in a service accept message. This approach can use temporary identifiers for delivering the message to the user equipment.

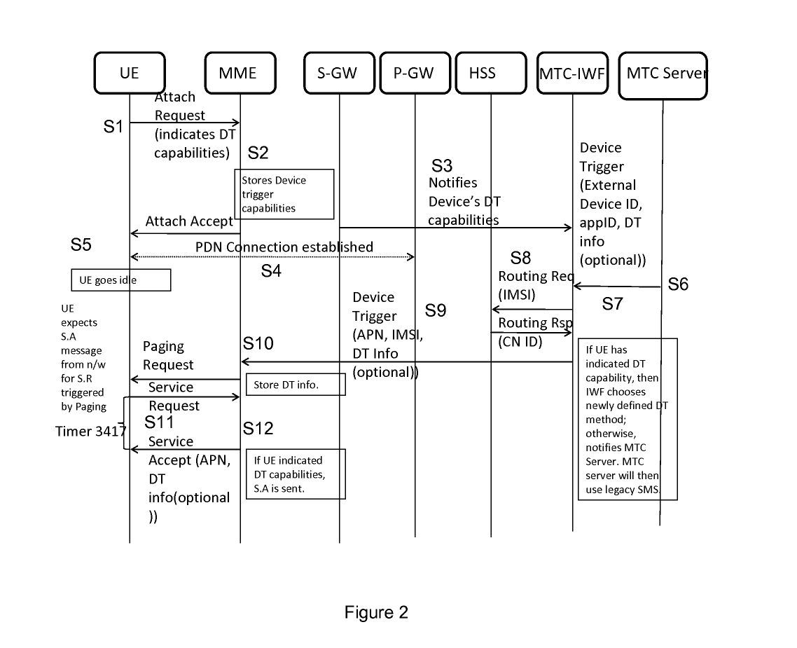

FIG. 2 illustrates device trigger delivery using service accept, with the user equipment in idle mode according to certain embodiments. Some details that are not relevant to a device trigger procedure are neither shown nor discussed. As shown in FIG. 2, at S1, the user equipment initiates an attach request and indicates the device trigger capabilities of the user equipment. Then, at S2, the mobility management entity processes the attach procedure and stores the device trigger capabilities. If the user equipment has indicated device trigger capabilities, at S3, the mobility management entity notifies the MTC-IWF of the device trigger capabilities. The mobility management entity can determine the MTC-IWF either based on configuration information within the mobility management entity or from a user's subscription information.

At S4, a packet data network connection for the device has been established either as part of attach procedure (for E-UTRAN) or subsequently (for UTRAN or GERAN; for GERAN and UTRAN establishment of a packet data network connection is optional, as it is not needed for the device trigger procedure). Then, at S5, the user equipment goes idle.

Subsequently, at S6, a machine type communication user can identify the need to trigger the device and can inform the machine type communication server. The machine type communication server, at S7, requests the IWF to trigger the device. The server provides, for example, the external identifier, application identifier for the device. Then, at S8, the MTC-IWF ensures it is an authentic request and may translate the appID to access point name, extID to IMSI and request the routing info (serving CN ID) from the home subscriber server by providing the IMSI for the device.

At S9, the MTC-IWF can use the CN ID to send a device trigger request message to the serving mobility management entity/SGSN. Then, at S10, the mobility management entity/SGSN can receive the device trigger message, and notice that the device is in idle mode. Thus, the mobility management entity/SGSN can store the device trigger information and page the user equipment.

Then, at S11, the user equipment can respond with a service request message (in GERAN: an LLC frame). Finally, at S12, since the user equipment indicated device trigger capabilities, it starts the timer T3417 and is expecting a service accept message from the network. The network can respond with a service accept message, which includes the necessary device trigger information.

Approach 3

In a third embodiment, delivery of device trigger info can take place in a non-access stratum (NAS) message. If a mobility management entity/SGSN or MTC-IWF supports compression capability, device trigger information could be compressed and included in the NAS message. The mobility management entity/SGSN uses temporary identifiers for delivering the message to the UE.

There may be two variations on this third embodiment. In a first variation, the triggering is performed while the user equipment is initially in an idle mode. In a second variation, the triggering is performed when the user equipment is initially in a connected mode.

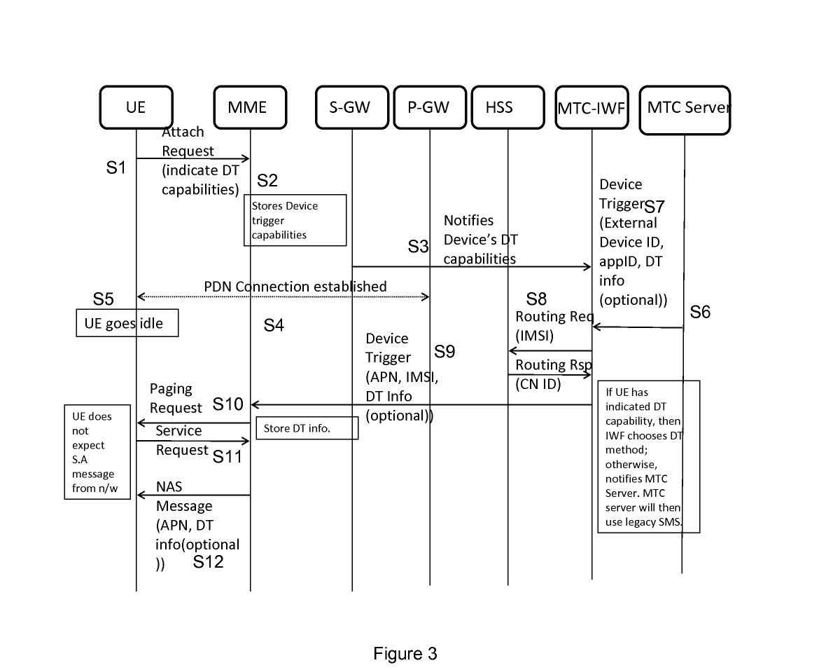

FIG. 3 illustrates device trigger delivery using an NAS message when the user equipment is in idle mode according to certain embodiments. Some details that are irrelevant to a device trigger procedure are not shown or discussed. As shown in FIG. 3, at S1, the user equipment initiates an attach request and indicates the user equipment's device trigger capabilities in the device properties section of the request. The mobility management entity processes the attach procedure and, at S2, stores the device trigger capabilities. If the user equipment has indicated device trigger capabilities, then, at S3, the mobility management entity provides notification of the device trigger capabilities to the MTC-IWF. The mobility management entity can determine the appropriate MTC-IWF either based on configuration information within the mobility management entity or from the user's subscription information.

At S4, the packet data network connection for the device has been established, either as part of attach procedure (for E-UTRAN) or subsequently (for UTRAN, GERAN; for GERAN and UTRAN establishment of a packet data network connection is optional, because it is not needed for the device trigger procedure). Then, at S5, the user equipment can go idle.

Subsequently, at S6, a machine type communication user can identify the need to trigger the device and can inform the machine type communication server. The machine type communication server can, at S7, request the IWF to trigger the device. The server can provide, among other things, the external identifier and application identifier for the device.

At S8, the MTC-IWF authenticate the request, translate the appID to APN and extID to IMSI, and send a request to the home subscriber server for the routing info (serving CN ID) by providing the IMSI of the device. The MTC-IWF can use the CN ID to send, at S9, a device trigger request message to the serving mobility management entity/SGSN.

Then, at S10, the mobility management entity/SGSN can receive the device trigger message, notice that the device is in idle mode, and consequently store the device trigger information and page the user equipment. When, at S11, the user equipment responds with a service request message (in GERAN: an LLC frame), since the user equipment indicated device trigger capabilities, at S12 the network sends a non-access stratum (NAS) message (for example, device trigger notification) encapsulating the necessary device trigger information.

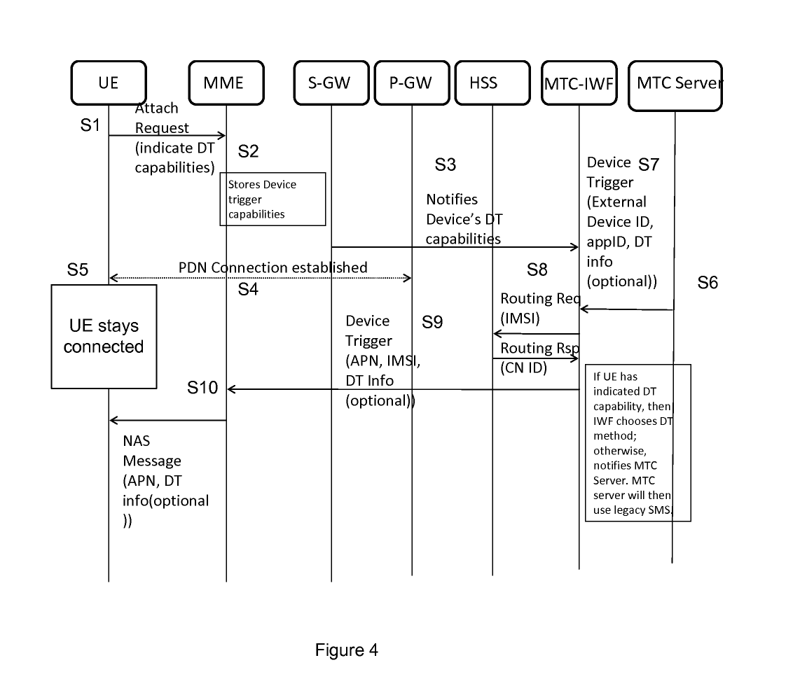

FIG. 4 illustrates device trigger delivery using an NAS message, when the user equipment is in connected mode according to certain embodiments. Some details that are irrelevant to a device trigger procedure are neither shown nor discussed. As shown in FIG. 4, at S1, the user equipment can initiate an attach request and indicate the device trigger capabilities of the user equipment in the Device properties. At S2, the mobility management entity processes the attach procedure and stores device properties, in this example.

Then, if the user equipment has indicated device trigger capabilities, then, at S3, the mobility management entity notifies the MTC-IWF of the device trigger capabilities of the user equipment. The mobility management entity can determine the MTC-IWF either based on configuration information within the mobility management entity, from user's subscription information, or any other way.

The packet data network connection for the device has been established, at S4, either as part of an attach procedure (for E-UTRAN) or subsequently (for UTRAN or GERAN; for GERAN and UTRAN, establishment of a packet data network connection is optional, in that such a connection is not needed for the device trigger procedure.

At S5, the user equipment can stay connected. Then, at S6, the machine type communication user can identify the need to trigger the device and can inform the machine type communication server.

The machine type communication server can, at S7, request the IWF to trigger the device. The server can provide, for example, the external identifier, application identifier for the device, and the like. The MTC-IWF can ensure that the request is an authentic request and can translate the appID to access point name and the extID to IMSI. At S8, the MTC-IWF can request from the home subscriber server the routing info (serving CN ID) by providing the IMSI for the device.

At S9, the MTC-IWF can use the CN ID to send a device trigger request message to the serving mobility management entity/SGSN. Finally, at S10, the mobility management entity/SGSN can receive the device trigger message, notice that the device is in connected mode, and send a non-access stratum (NAS) message (for example, a device trigger notification) encapsulating the necessary device trigger information to the user equipment.

Various embodiments may have benefits. In general, for GERAN/UTRAN: No CS infrastructure needed in a PS only environment e.g. Circuit Core—SS7 Signaling Network—SMSC not needed; (reduces deployment cost where this is not already deployed); Involved network elements—Radio Network, Packet Core, MTC-IWF. Likewise, for E-UTRAN: no “real” circuit switched infrastructure is needed. If the first embodiment described above (SMS) is to be supported for legacy UEs, either an SGs interface and some related circuit switched infrastructure can be used, or the mobility management entity can support at least the NAS signaling procedure for a combined attach for evolved packet system (EPS) service and SMS only towards the UE (without necessarily performing the signaling to the MSC/VLR via the SGs interface). Moreover, certain embodiments may work without assignment of MSISDN to the device.

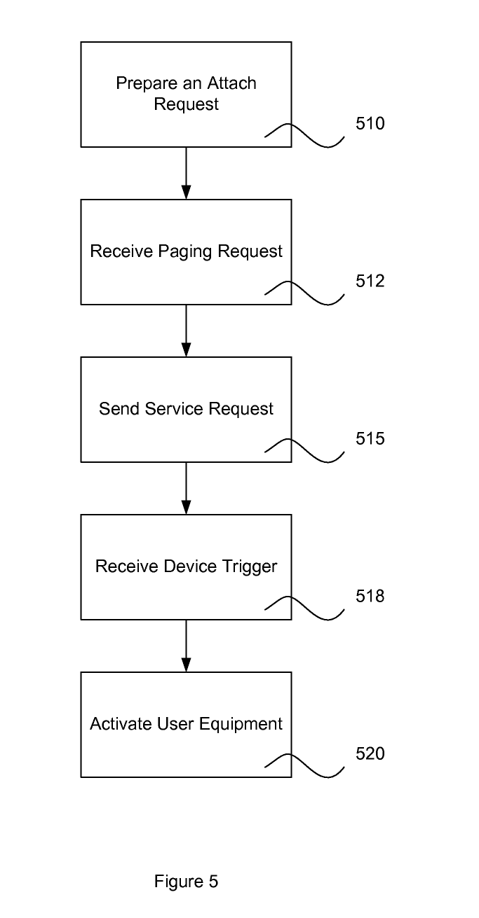

FIG. 5 illustrates a method according to certain embodiments. The method shown in FIG. 5 may be performed by, for example, a user equipment, which may be a machine type communication device. As shown in FIG. 5, a method can include, at 510, preparing an attach request to be sent to a network element, wherein the attach request comprises an indication of a device trigger capability of a user equipment. The method can also include, at 520, activating the user equipment in response to a received device trigger, received at 518.

The method can additionally include, at 515, sending a service request in response to a received paging request (received at 512). The activating the user equipment can be in response to the received device trigger (at 518) and the received device trigger can be received in response to the service request. The activating the user equipment can performed in response to the received device trigger (received at 518) and the received device trigger can be received in a non-access stratum message. In such a case, the paging request and response thereto may be omitted.

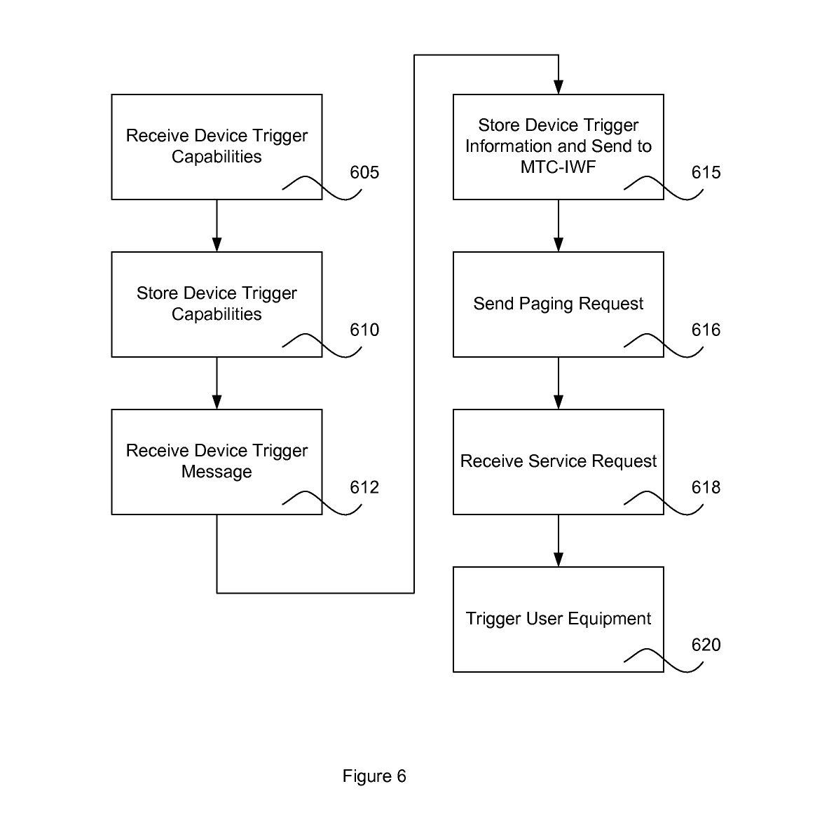

FIG. 6 illustrates another method according to certain embodiments. The method of FIG. 6 may be performed by a network element such as, for example, a mobility management entity or SGSN. As shown in FIG. 6, a method can include, at 610, storing a device trigger capability of a user equipment received (at 605) from the user equipment. The method can also include, at 620, triggering the user equipment upon receiving (at 612) a device trigger message from a machine type communication interworking function.

The method can further include, at 615, storing device trigger information from the device trigger message and sending the device trigger capability of the user equipment to a machine type communication interworking function (MTC-IWF). The triggering the user equipment (at 620) can be performed after receiving (at 618) a service request from the user equipment. The method can additionally include, at 616, sending a paging request to the user equipment in order to receive (at 618) a responsive service request prior to triggering the user equipment. The triggering the user equipment can include sending at least one of a short message service message without the use of a short message service center or mobile switching center, a service accept message, or a non-access stratum device trigger message.

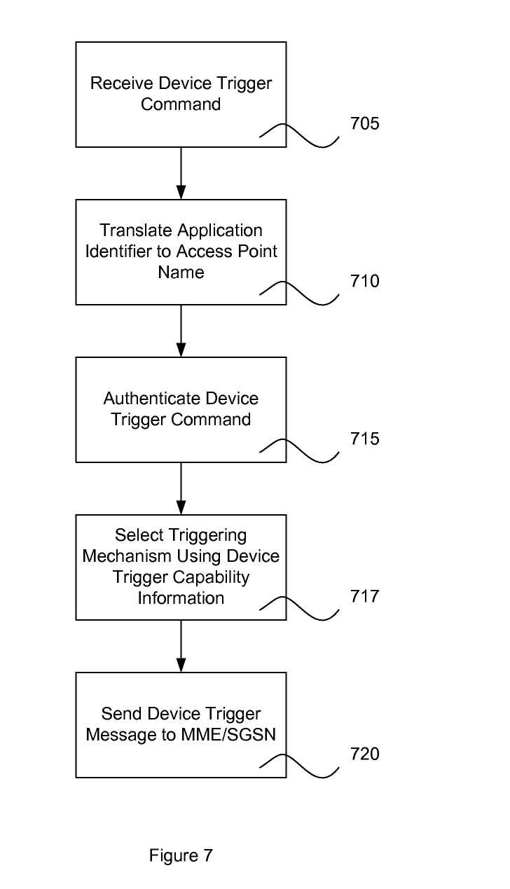

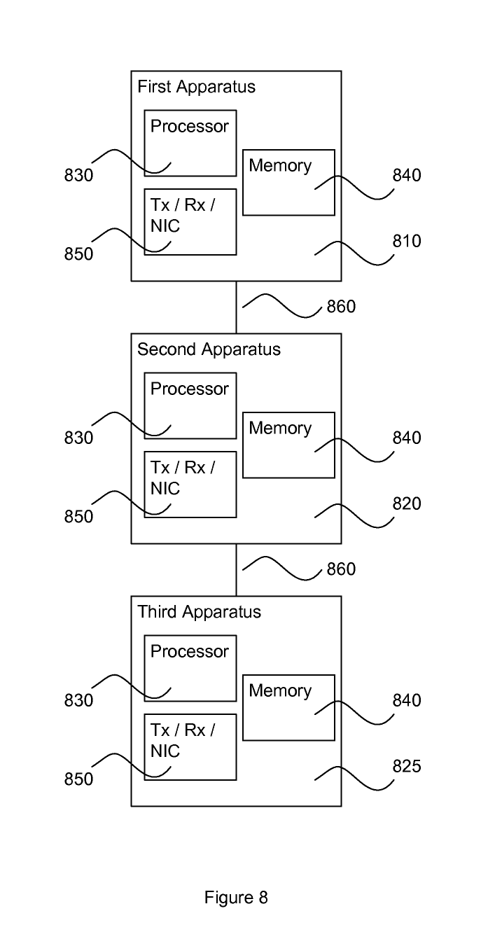

FIG. 7 illustrates a further method according to certain embodiments. The method of FIG. 7 may be performed by a network element such as, for example, a machine type communication interworking function (MTC-IWF). As shown in FIG. 7, a method can include, at 710, translating an application identifier to an access point name in response to receiving (at 705) a device trigger message for a user equipment from a machine type communication server. The access point name information can be used by the user equipment to establish user plane connection with a gateway. The method can also include, at 720, sending a device trigger message to a network element serving the user equipment based on obtained routing information. The method can further include, at 715, authenticating the device trigger message prior to obtaining the routing information. The method can additionally include, at 717, selecting a triggering mechanism for the user equipment using a device trigger capability received from a mobility management entity.

The sending the device trigger message to the network element can include sending the device trigger message to at least one of a mobility management entity and a serving general packet radio service support node. In certain embodiments the machine type communication server and MTC-IWF can be co-located. In such an embodiment, the “message” from the server may be an internal message within the device that includes both the server and the MTC-IWF. The server itself may obtain the device trigger command from a machine type communication user.

FIG. 8 illustrates a system according to certain embodiments of the present invention. As shown in FIG. 8, the system can include a first apparatus 810 (such as a user equipment), a second apparatus 820 (such as a mobility management entity or SGSN), and a third apparatus 825 (such as a MTC-IWF). Each of the apparatuses may be equipped with at least one processor 830, at least one memory 840 (including computer program instructions), and transceiver/network interface card 850 (other communications equipment, such as an antenna, may also be included). The apparatuses may be configured to communicate with one another over interfaces 860, which are shown as wired interfaces, but may incorporate both wireless and wired interfaces, and may be merely wireless interfaces.

The at least one processor 830 can be variously embodied by any computational or data processing device, such as a central processing unit (CPU) or application specific integrated circuit (ASIC). The at least one processor 830 can be implemented as one or a plurality of controllers.

The at least one memory 840 can be any suitable storage device, such as a non-transitory computer-readable medium. For example, a hard disk drive (HDD) or random access memory (RAM) can be used in the at least one memory 840. The at least one memory 840 can be on a same chip as the at least one processor 830, or may be separate from the at least one processor 830.

The computer program instructions may be any suitable form of computer program code. For example, the computer program instructions may be a compiled or interpreted computer program.

The at least one memory 840 and computer program instructions can be configured to, with the at least one processor 830, cause a hardware apparatus (for example, a user equipment, mobility management entity, or MTC-IWF) to perform a process, such as the processes shown in FIGS. 2-7 or any other process described herein.

Thus, in certain embodiments, a non-transitory computer-readable medium can be encoded with computer instructions that, when executed in hardware perform a process, such as one of the processes described above. Alternatively, certain embodiments of the present invention may be performed entirely in hardware.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
preparing an attach request to be sent to a network element, wherein the attach request comprises an indication of a device trigger capability of a user equipment; and
activating the user equipment in response to a received device trigger.

2. The method of claim 1, further comprising:
sending a service request in response to a received paging request, wherein the activating the user equipment is in response to the received device trigger and the received device trigger is received in response to the service request.

3. The method of claim 1, wherein the activating the user equipment is performed in response to the received device trigger and the received device trigger is received in a non-access stratum message.

4. A method, comprising:
storing a device trigger capability of a user equipment received from the user equipment; and
triggering the user equipment upon receiving a device trigger message from a machine type communication interworking function.

5. The method of claim 4, further comprising:
storing device trigger information from the device trigger message, wherein the triggering the user equipment is performed after receiving a service request from the user equipment.

6. The method of claim 4, further comprising:
sending a paging request to the user equipment in order to receive a responsive service request prior to triggering the user equipment.

7. The method of claim 4, wherein the triggering the user equipment comprises sending at least one of a service accept message, a non-access stratum device trigger message, or a short message service message without the use of a short message service center or mobile switching center.

8. The method of claim 4, further comprising:
sending the device trigger capability of the user equipment to a machine type communication interworking function.

9. A method, comprising:
translating an application identifier to an access point name in response to receiving a device trigger message for a user equipment from a machine type communication server.

10. The method of claim 9, further comprising:
selecting a triggering mechanism for the user equipment using a device trigger capability received from a mobility management entity.

11. An apparatus, comprising:
at least one memory including computer program instructions; and
at least one processor,
wherein the at least one memory and computer program instructions are configured to, with the at least one processor, cause the apparatus at least to
prepare an attach request to be sent to a network element, wherein the attach request comprises an indication of a device trigger capability of a user equipment; and
activate the user equipment in response to a received device trigger.

12. The apparatus of claim 11, wherein the at least one memory and computer program instructions are configured to, with the at least one processor, cause the apparatus at least to send a service request in response to a received paging request, wherein the user equipment is activated in response to the received device trigger and the received device trigger is received in response to the service request.

13. The apparatus of claim 11, wherein the at least one memory and computer program instructions are configured to, with the at least one processor, cause the apparatus at least to activate the user equipment in response to the received device trigger and the received device trigger is received in a non-access stratum message.

14. An apparatus, comprising:
at least one memory including computer program instructions; and
at least one processor,
wherein the at least one memory and computer program instructions are configured to, with the at least one processor, cause the apparatus at least to
store a device trigger capability of a user equipment received from the user equipment; and
trigger the user equipment upon receiving a device trigger message from a machine type communication interworking function.

15. The apparatus of claim 14, wherein the at least one memory and computer program instructions are configured to, with the at least one processor, cause the apparatus at least to store device trigger information from the device trigger message, wherein the user equipment is triggered after receiving a service request from the user equipment.

16. The apparatus of claim 14, wherein the at least one memory and computer program instructions are configured to, with the at least one processor, cause the apparatus at least to send a paging request to the user equipment in order to receive a responsive service request prior to triggering the user equipment.

17. The apparatus of claim 14, wherein the at least one memory and computer program instructions are configured to, with the at least one processor, cause the apparatus at least to trigger the user equipment by sending at least one of a service accept message, a non-access stratum device trigger message, or a short message service message without the use of a short message service center or mobile switching center.

18. The apparatus of claim 14, wherein the at least one memory and computer program instructions are configured to, with the at least one processor, cause the apparatus at least to send the device trigger capability of the user equipment to a machine type communication interworking function.

19. An apparatus, comprising:
at least one memory including computer program instructions; and
at least one processor,
wherein the at least one memory and computer program instructions are configured to, with the at least one processor, cause the apparatus at least to
translate an application identifier to an access point name in response to receiving a device trigger message for a user equipment from a machine type communication server.

20. The apparatus of claim 19, wherein the at least one memory and computer program instructions are configured to, with the at least one processor, cause the apparatus at least to select a triggering mechanism for the user equipment using a device trigger capability received from a mobility management entity.

21. An apparatus, comprising:
preparing means for preparing an attach request to be sent to a network element, wherein the attach request comprises an indication of a device trigger capability of a user equipment; and
activating means for activating the user equipment in response to a received device trigger.

22. The apparatus of claim 21, further comprising:
sending means for sending a service request in response to a received paging request, wherein the activating the user equipment is in response to the received device trigger and the received device trigger is received in response to the service request.

23. The apparatus of claim 21, wherein the activating the user equipment is performed in response to the received device trigger and the received device trigger is received in a non-access stratum message.

24. An apparatus, comprising:
storing means for storing a device trigger capability of a user equipment received from the user equipment; and
triggering means for triggering the user equipment upon receiving a device trigger message from a machine type communication interworking function.

25. The apparatus of claim 24, further comprising:
storing means for storing device trigger information from the device trigger message, wherein the triggering the user equipment is performed after receiving a service request from the user equipment.

26. The apparatus of claim 24, further comprising:
sending means for sending a paging request to the user equipment in order to receive a responsive service request prior to triggering the user equipment.

27. The apparatus of claim 24, wherein the triggering the user equipment comprises sending at least one of a service accept message, a non-access stratum device trigger message, or a short message service message without the use of a short message service center or mobile switching center.

28. The apparatus of claim 24, further comprising:
sending means for sending the device trigger capability of the user equipment to a machine type communication interworking function.

29. An apparatus, comprising:
receiving means for receiving a device trigger message for a user equipment from a machine type communication server; and
translating means for translating an application identifier to an access point name in response to receiving the device trigger message.

30. The apparatus of claim 29, further comprising:
selecting means for selecting a triggering mechanism for the user equipment using a device trigger capability received from a mobility management entity.

31. A non-transitory computer readable medium encoded with instructions that, when executed in hardware, perform a process, the process comprising the method according to claim 1.
